(19) United States
(12) Patent Application Publication
(10) Pub. No.: US 2014/0295218 A1
(43) Pub. Date: Oct. 2, 2014

(54) METHOD OF DETECTING LITHIUM-ION CELL DAMAGE VIA VAPOR DETECTION

(71) Applicants: Eva Hakansson, Wheat Ridge, CO (US); William Dube, Wheat Ridge, CO (US)

(72) Inventors: Eva Hakansson, Wheat Ridge, CO (US); William Dube, Wheat Ridge, CO (US)

(21) Appl. No.: 13/851,823

(22) Filed: Mar. 27, 2013

(51) Int. Cl. H01M 10/48

(52) U.S. Cl. CPC H01M 10/48; H01M 10/488
USPC 429/50; 429/61

(57) ABSTRACT

The present invention teaches providing a sensor capable of detecting organic vapors in close proximity to the li-ion battery, these organic vapors being reliable indicators of battery troubles before the battery troubles even manifest themselves. The sensor may initiate (actuate) various responses such as alarm indicators of various types, changing the mode of usage of the battery or even taking the battery off-line. The organic vapors may be any of a wide range of types as a degrading li-ion battery may emit any one of a wide range of different organic compounds. The invention may also be used with batteries immersed in fluids. Numerous types of li-ion battery may use the device, which is much faster than a post-failure smoke detection.

### STATEMENT REGARDING FEDERALLY FUNDED RESEARCH

This invention was not made under contract with an agency of the US Government, nor by any agency of the US Government.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### CROSS-REFERENCE TO RELATED APPLICATIONS

N/A

### FIELD OF THE INVENTION

This invention relates generally to lithium-ion batteries, and specifically to safety and early detection of cell degradation.

### BACKGROUND OF THE INVENTION

The lithium-ion battery has established itself as one of the major enabling technologies of the present generation. The modern cell phone, the newest generation of electric cars and many other cutting edge technologies of the present are in fact controlled strictly by what can be done with lithium-ion battery technology in terms of power, size, and safety.

The typical lithium-ion battery has two electrodes which able to absorb lithium ions, one during charging and the other during usage. An organic solvent carries lithium ions in the form of salts. Movement of the electrical charges on the lithium ions provides the electrical power source of the battery, however, lithium itself is an extremely reactive element. Metallic lithium (which is NOT used in lithium-ion batteries) more or less burns very energetically in contact with water, and even the lithium salts used in a li-ion battery are highly reactive, enough so that li-ion batteries must at all times be sealed in a strong casing which prevents air and water (and anything else) from entering the battery and allowing unintended and uncontrolled electro-chemical reactions, many of which are highly exothermic. With the exception of those cells which are designed to vent, the case also prevents the contents of the battery from leaking out. During normal operation, li-ion batteries are not designed for venting. However, most or all batteries do usually have vents, if only for emergencies. But even with batteries designed to vent routinely, the vent is designed to prevent the contents from leaking.

Li-ion batteries are extremely fragile in terms of electrical discharge and recharge. Overcharging, over-heating, and even certain types of discharging can cause damage to the batteries. This damage can have fairly catastrophic results: li-ion batteries can burst into flames, rupture and spill the lithium-salts and organic solvents, overheat and destroy nearby mechanisms and so on and so forth.

The dangers of li-ion batteries have in fact become somewhat infamous in some areas: a brand new model of airliner has been grounded due to no apparent fault whatsoever of the manufacturer but merely due to the nature of li-ion batteries. Numerous cases of laptop computer batteries rupturing and even entering runaway exothermic reaction states have occurred. In other areas, a great deal of li-ion battery failure experience has been accrued without significant attention.

As a result of the dangers of li-ion batteries, a nascent li-ion safety industry has finally sprung up. Various methods are suggested by the prior art. The most common family of li-ion battery safety methods revolve around analysis of the current characteristics the battery pack displays during use or recharging. Examples of this include US Patent Publication No. 20090021217, which actually discusses the electro-chemical reactions within the cell which lead to venting and yet which then teaches away from the method of the present invention. That patent application instead teaches monitoring of the electrical properties of the cell (current, voltage) and looking for the electrical signature of failure. Other patent applications share this feature of teaching toward analysis of electrical properties and teaching away from the analysis of the present invention.

Another interesting method of detecting problems with li-ion batteries is very clever, using a laser in its detection process: US Patent Publication No. 20110236735. This application again teaches the buildup of gas inside the cell, but as with other applications then goes off track from the method of the present invention and instead uses a method geared toward detecting an actual rupture of the cell, or a fire from the cell. The present invention actually teaches toward preventative care of the cell, allowing accurate prediction of cell failure well in advance.

It is worth noting that all of these methods teach away from a chemical analysis of the battery environment, for example teaching away from the method of the present invention. It is further worth noting that all of these methods assume the actual failure of the cell as a PREREQUISITE for detection of failure, after the failure has already occurred.

One interesting item even assumes that in the event of a kinetic automobile accident causing physical breach of the battery pack, the battery will in fact be in flames or at least emitting dense clouds of smoke, and uses a smoke detector to . . . roll down the windows of the effected vehicle. US Patent Publication No. 20110059341 teaches that li-ion batteries inside of automobiles might burst into flames in the aftermath of an automobile accident, so a smoke or flame detector could then be of use. However, this patent says nothing about using a vapor sensor to detect degradation of internal origin in a battery or cell, nor about doing so prior to the cell displaying symptoms of degradation.

However, there does not seem to be teaching in the prior art that a sensor can monitor a cell, group of cells, battery, battery pack or group of batteries or packs without any intrusion nor even physical contact with the battery/cell and yet, by checking the emissions of the battery, not just detect the failure of the battery but in fact, PRIOR TO ANY FAILURE AND EVEN PRIOR ANY ELECTRICAL DEGRADATION, detecting the damage to a cell/battery.

It would obviously be preferable to detect impending failure rather than failure, to detect problems with li-ion cells prior actual ignition, and to be able to act on this detection.

### SUMMARY OF THE INVENTION

### General Summary

As previously mentioned, there are technical areas in which a great deal of li-ion battery failure experience has been accrued without significant attention. One such area is the mechanically grueling motor sport of vehicular racing.

In typical speed contests such as drag racing, a vehicles petrochemically driven engine or electrically driven motor are expected to accelerate the vehicle to high speed in extraordinarily short times. Jet engines have been used in dragsters, as have exotic fuels and more. In this sport it is considered perfectly normal to overhaul an engine after even a single race if there is a need. One increasingly successful part of the drag racing sport is the electric vehicle division. An electric motorcycle has clocked a zero to sixty miles per hour time of under one second. Obviously, this and similar feats rely upon a sudden, heavy discharge of li-ion batteries. The natural result is acquisition of a great deal of experience in the extremely specialized area of abusing li-ion batteries.

It has been found that degrading li-ion batteries begin to emit various organic compounds prior to actual failure, even prior to any changes in electrical behavior. Thus the present invention teaches that li-ion batteries may be monitored non-intrusively, individually or en masse, simply by monitoring the presence and amount of organic vapor present in the air or other surrounding gas close to the li-ion battery or in the liquid surrounding those batteries which operate immersed in liquid.

The present invention teaches providing a sensor capable of detecting organic vapors in close proximity to the li-ion battery, these organic vapors being reliable indicators of battery troubles before the battery troubles even manifest themselves. The sensor may initiate (actuate) various responses such as alarm indicators of various types, changing the mode of usage of the battery or even taking the battery off-line. For purposes of this application the term ‘shut down’ of a battery refers to reducing, limiting, ceasing entirely the charging or discharging of a battery or cell.

The organic vapors may be any of a wide range of types as a degrading li-ion battery may emit any one of a wide range of different organic compounds.

The organic vapors may be emitted by a wide range of types of sealed batteries including not just lithium-ion batteries but also lithium metal batteries and sealed sodium, molten salt, molten sulfur and similar sealed batteries as well. In the cases of some types of batteries, the vapors may technically be non-organic, however for purposes of this application these are included in the term.

### Summary in Reference to Claims

It is therefore another aspect, advantage, objective and embodiment of the invention, in addition to those discussed previously, to provide a method of detecting battery degradation in a lithium-ion battery, the method comprising the steps of: providing a lithium-ion battery; providing a vapor detector situated so as to sense any vapor emitted from the battery; providing a response to vapor detection; and when the vapor detector senses vapor emitted from the battery, actuating the response.

It is therefore another aspect, advantage, objective and embodiment of the invention, in addition to those discussed previously, to provide a method of detecting battery degradation in a lithium-ion battery, the response further comprising: an indicator selected from the group consisting of: lights, visual signals, bells, tones, audible signals, illuminated lettering, haptic signals, and combinations thereof.

It is therefore another aspect, advantage, objective and embodiment of the invention, in addition to those discussed previously, to provide a method of detecting battery degradation in a lithium-ion battery, the response further comprising: actuation of a fire extinguisher/fire suppression system.

It is therefore another aspect, advantage, objective and embodiment of the invention, in addition to those discussed previously, to provide a method of detecting battery degradation in a lithium-ion battery, the response further comprising: switching from a first mode of operation of a battery management system which manages the lithium-ion battery to a second mode of operation of the battery management system.

It is therefore another aspect, advantage, objective and embodiment of the invention, in addition to those discussed previously, to provide a method of detecting battery degradation in a lithium-ion battery, the second mode of operation of the battery management system further comprising: shut down of the battery.

It is therefore another aspect, advantage, objective and embodiment of the invention, in addition to those discussed previously, to provide a method of detecting battery degradation in a lithium-ion battery, the second mode of operation of the battery management system further comprising: shut down of a portion of the battery.

It is therefore another aspect, advantage, objective and embodiment of the invention, in addition to those discussed previously, to provide a method of detecting battery degradation in a lithium-ion battery, the lithium-ion battery being one member selected from the group consisting of: li-ion batteries with ethylene carbonate solvent, li-ion batteries with dimethyl carbonate solvent, li-ion batteries with diethyl carbonate solvent, composite solvents, solvents of the poly(oxyethylene) family, lithium cobalt oxide batteries, lithium titanate batteries, lithium manganese oxide batteries, lithium iron phosphate batteries, lithium nickel manganese cobalt oxide, lithium nickel cobalt aluminum oxide and combinations thereof.

It is therefore another aspect, advantage, objective and embodiment of the invention, in addition to those discussed previously, to provide a method of detecting battery degradation in a lithium-ion battery, wherein the vapor detector further comprises: a detector of organic vapor products of lithium-ion battery operation.

It is therefore another aspect, advantage, objective and embodiment of the invention, in addition to those discussed previously, to provide a method of detecting battery degradation in a lithium-ion battery, wherein the vapor detector further comprises: a detector of flammable vapors.

It is therefore yet another aspect, advantage, objective and embodiment of the invention, in addition to those discussed previously, to provide a method of detecting battery degradation in a lithium-ion battery, the method comprising the steps of: providing a lithium-ion battery immersed in a liquid; providing a submerged organic molecule detector situated so as to sense organic chemicals emitted from the battery; providing a response to organic chemical detection; and when the submerged organic molecule detector senses organic chemicals emitted from the battery, actuating the response.

It is therefore yet another aspect, advantage, objective and embodiment of the invention, in addition to those discussed previously, to provide a method of detecting battery degradation in a lithium-ion battery, the response further comprising: an indicator selected from the group consisting of: lights, visual signals, bells, tones, audible signals, illuminated lettering, haptic signals, and combinations thereof.

It is therefore another aspect, advantage, objective and embodiment of the invention, in addition to those discussed previously, to provide a method of detecting battery degradation in a lithium-ion battery, the response further comprising: switching from a first mode of operation of a battery management system which manages the lithium-ion battery to a second mode of operation of the battery management system.

It is therefore another aspect, advantage, objective and embodiment of the invention, in addition to those discussed previously, to provide a method of detecting battery degradation in a lithium-ion battery, the second mode of operation of the battery management system further comprising: shut down of the battery.

It is therefore another aspect, advantage, objective and embodiment of the invention, in addition to those discussed previously, to provide a method of detecting battery degradation in a lithium-ion battery, the lithium-ion battery being one member selected from the group consisting of: li-ion batteries with ethylene carbonate solvent, li-ion batteries with dimethyl carbonate solvent, li-ion batteries with diethyl carbonate solvent, composite solvents, solvents of the poly(oxyethylene) family, lithium cobalt oxide batteries, lithium titanate batteries, lithium manganese oxide batteries, lithium iron phosphate batteries, lithium nickel manganese cobalt oxide, lithium nickel cobalt aluminum oxide and combinations thereof.

It is therefore yet another aspect, advantage, objective and embodiment of the invention to provide a battery system comprising: at least one sealed lithium-ion cell; at least one gas detector situated so as to detect any gas emitted by such sealed lithium-ion cell; at least one responding system, the gas detector operative to actuate the responding system.

It is therefore yet another aspect, advantage, objective and embodiment of the invention to provide a battery system wherein the response further comprises: an indicator selected from the group consisting of: lights, visual signals, bells, tones, audible signals, illuminated lettering, haptic signals, and combinations thereof.

It is therefore yet another aspect, advantage, objective and embodiment of the invention to provide a battery system wherein the response further comprises: actuation of a fire extinguisher/fire suppression system.

It is therefore yet another aspect, advantage, objective and embodiment of the invention to provide a battery system wherein the response further comprises: switching from a first mode of operation of a battery management system which manages the lithium-ion battery to a second mode of operation of the battery management system.

It is therefore yet another aspect, advantage, objective and embodiment of the invention to provide a battery system in which the second mode of operation of the battery management system further comprises: shut down of the battery.

### BRIEF DESCRIPTION OF THE DRAWINGS

FIG. 1 is a perspective view of a single lithium-ion cell showing the cell, a characteristic or exemplary vapor plume and a sensor for vapor detection.

FIG. 2 is a partially cut-away perspective view of a battery showing several cells, one of which emits vapor, and a sensor disposed so as to detect vapor within the battery.

FIG. 3 is a perspective view of a pouch cell battery pack with the invention employed to detect a cell or group of cells degrading.

FIG. 4 is a perspective view of a battery pack utilizing cylindrical cells, a battery management system, and the method of the invention.

FIG. 5 is a perspective view of a battery pack of the type which is immersed in liquid, demonstrating that the method of the invention may additionally be employed with submerged sensors.

FIG. 6 is a flow chart embodiment of the method of the invention, showing the steps of the invention.

### INDEX TO REFERENCE NUMERALS

### Table One

110 li-ion battery
120 organic vapor emission
130 organic vapor detector/sensor
140 vent
210 group of cells
220 vapor
230 sensor
230 enclosure
310 group of pouch-type li-ion battery cells
320 vapor
330 sensor
410 cylindrical li-ion battery cells
420 vapor
430 sensor
440 battery management system
450 insulating barrier
510 cylindrical cell (immersed/submerged)
520 vapor from liquid surface
530 vapor sensor
540 battery management system (module)
560 liquid
570 electrolyte in liquid
580 sensor (submerged/immersed at least in part)
605 provide li-ion battery, vapor detector and response system
615 monitor vapor levels for detection of vapor
625 compare detected vapor level to predetermined level
635 if detected vapor level subceeds predetermined level, actuate alarm
645 if detected vapor level exceeds predetermined level, actuate secondary mode of battery management system

### DETAILED DESCRIPTION

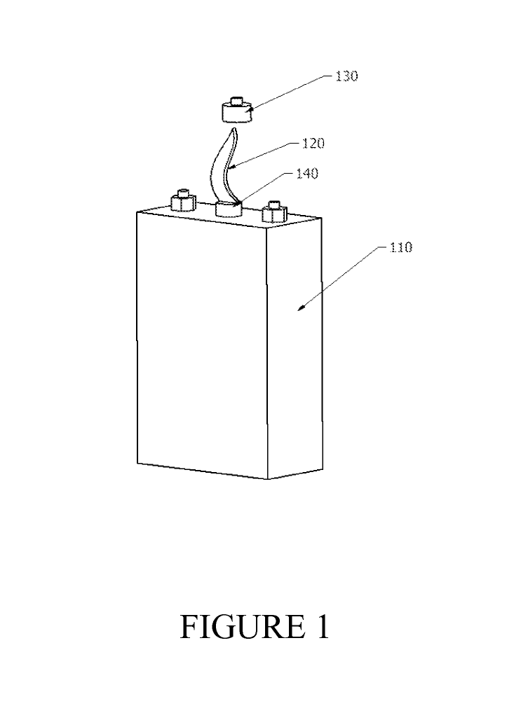

FIG. 1 is a perspective view of a single lithium-ion cell showing the cell, a characteristic or exemplary vapor plume and a sensor for vapor detection. Li-ion battery cell 110 is shown emitting organic vapor 120, depicted as a plume and which can be detected by organic vapor detector/sensor 130, which is provided in close proximity to the cell 110. Vent 140 is shown as many li-ion batteries have such a vent, however, it should be clearly understood that the invention actually works even with those batteries which are not vented and the invention is not limited by the presence or absence of a vent.

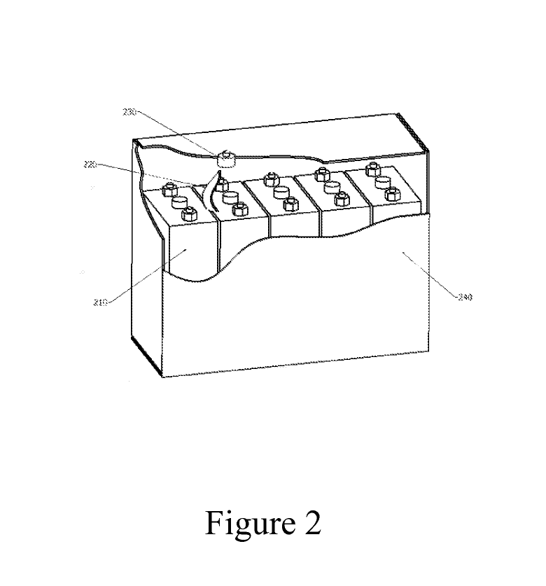

FIG. 2 is a partially cut-away perspective view of a battery showing several cells, one of which emits vapor, and a sensor disposed so as to detect vapor within the battery. In this preferred embodiment and best mode presently contemplated, group of cells 210 (prismatic) have a member which is degrading and is emitting vapor 220. Note that regardless of the location or identity of the cell which is failing, the vapor 220 will be detectable so long as the sensor 230 is properly placed. This is a marked advantage over systems which rely upon increases in resistance or decreases in output, as such systems normally measure the cells as a group 210.

Enclosure 240 is an important aspect of the invention, as the enclosure's shape and configuration will help to determine the placement of sensor 230.

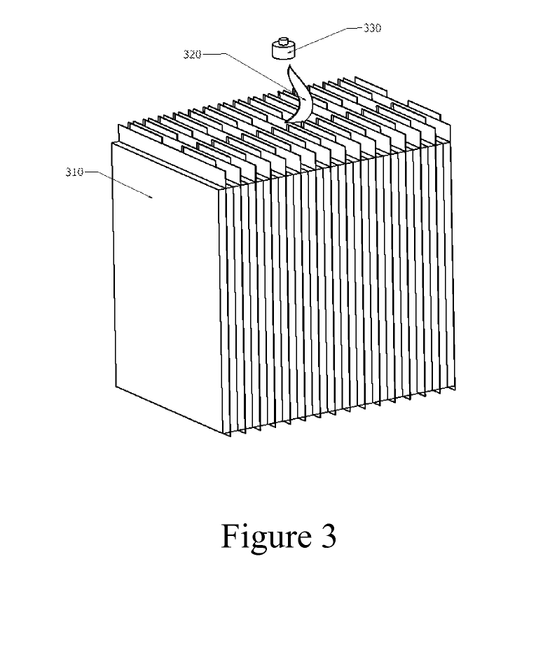

FIG. 3 is a perspective view of a pouch cell battery pack with the invention employed to detect a cell or group of cells degrading. Group of pouch-type li-ion battery cells 310 have a member which is degrading, and is depicted to be emitting vapor 320 despite the fact that will only a single cell degrading in such a large group, it is extremely hard to detect the fall-off in performance by means of current/voltage analysis as in the prior art.

Sensor 330 however is non-intrusive, since it does not need to even contact a single cell and yet can monitor a group of cells from a proximate location as shown.

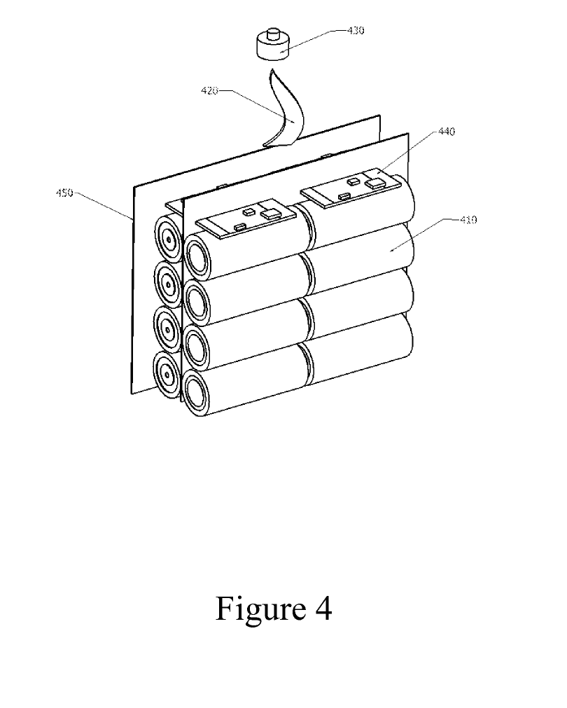

FIG. 4 is a perspective view of a battery pack utilizing cylindrical cells, a battery management system, and the method of the invention. While prismatic and pouch type cells are quite common, cylindrical li-ion battery cells 410 are also very common. Depending on weight and space, such packs may be interchangeable with other types of battery cell packs.

Vapor 420 may be seen to be detected by sensor 430, which will begin the process of a response to the detection.

Various responses are possible, depending on a number of factors. A system can be designed with a single response or with multiple responses.

Battery management system 440 (BMS) might be one target of such a response. BMS 440 might decrease the current (or wattage, etc) being drawn from the system so as to protect the battery and act to prevent a fire, or it might remove only some cells from the system's usage cycle, and so on and so forth.

Insulating barrier 450 might normally present an obstacle to other detection systems which rely upon intrusive measures, heat detection of cells already in an energetic exothermic state (i.e. on fire), or similar methods. But the method of the present invention is actually enhanced by the presence of barriers to gas diffusion such as enclosure 240 or barrier 450, since such barriers or enclosures may act to concentrate or contain vapors for detection. Obviously such barriers or enclosures do require that the sensor 430 be placed within them.

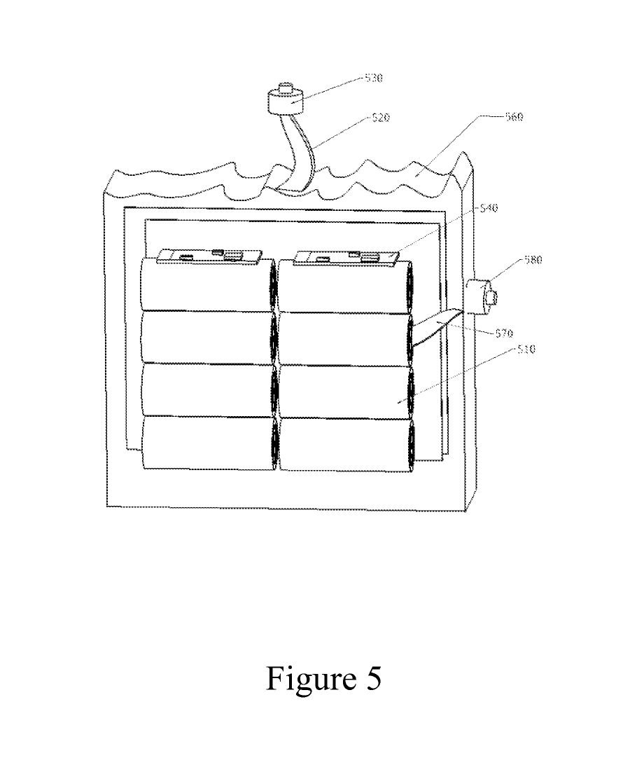

FIG. 5 is a perspective view of a battery pack of the type which is immersed in liquid, demonstrating that the method of the invention may additionally be employed with submerged sensors. Cylindrical cell 510 (immersed/submerged) is not uncommon in the li-ion battery industry.

Two methods of emission detection are presented. In the first method, vapor from the liquid surface 520 is detectable by vapor sensor 530. Since the electrochemistry inside of a li-ion battery cell is quite energetic, and since such cells are commonly used in mobile applications (cell phones) or even extremely kinetic applications (aircraft, electric race cars), the liquid surface is depicted to be roiled by the energy release and motion.

Battery management system (module) 540 may be immersed as well.

In the second method of detection, liquid 560 will have present in it electrolyte/solvent 570. It is worth noting that the present invention does not require a distinction be made between solvent fumes and related fumes, as almost any organic chemical detection is a sign of battery degradation.

As a result of the emission of such organic chemical into the liquid, sensor 580 (submerged/immersed at least in part) can detect the organic chemical even prior to it becoming vapor.

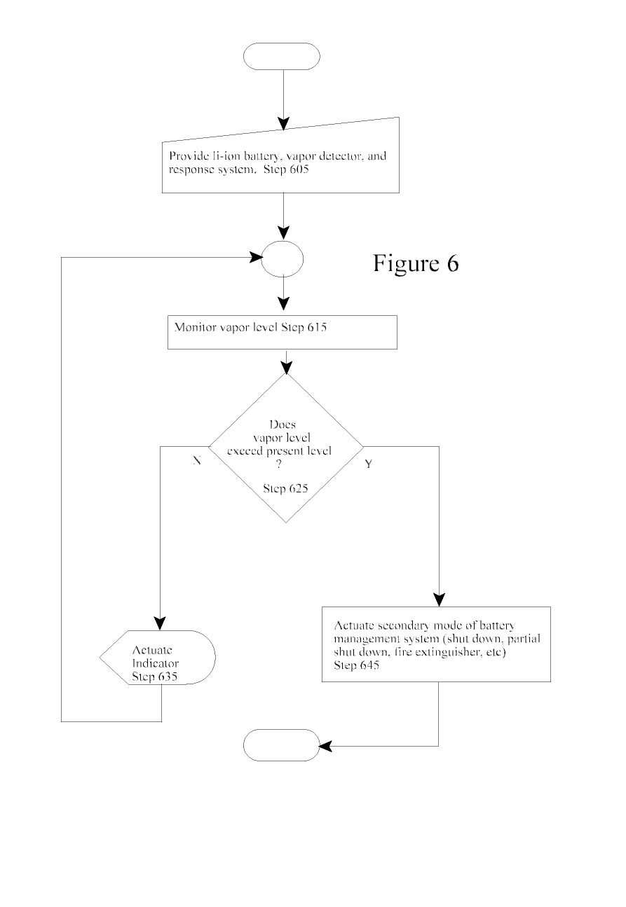

FIG. 6 is a flow chart embodiment of the method of the invention, showing the steps of the invention.

In step 605, the invention provides not only the li-ion battery, but also the vapor detector and response system.

At step 615, activity begins as the sensor begins to monitor vapor levels for detection of the organic vapor.

At step 625, any detected vapor level is compared to a predetermined level of vapor. In normal usage it is predictable that a certain percentage of cells will begin to fail but will do so slowly and non-catastrophically. One benefit of the present invention is not just that it can detect problems well in advance of smoke, heat or electrical failure (unlike the prior art) but that it can also grade the severity of such problems based upon predetermined levels. Thus, at some levels, it may be safe to actuate an indicator or make a log entry, while at other levels action as acute as taking the battery off-line may be required.

Thus a decision loop is depicted: monitor, detected, compare, take actions which leave the battery and loop in action, and continue until such time as more extreme failure might be detected.

At step 635 if detected vapor level subceeds (is less then) a predetermined level, the system will actuate an alarm, which might be a light, an electronic screen icon or image or word, an audio alarm and so on. A log entry might be made.

But on the other hand step 645 shows that if the detected vapor level exceeds the predetermined safety level, then the system may actuate a secondary mode of operation of the battery management system. In particular, the BMS might begin to alter the battery operation, shut it down, take it off line, remove certain banks of cells from operation, and so on and so forth.

Thus using a standard vapor and aerosol detector in a battery pack, one can detect the presence of any vapors and respond. There maybe one or many vapor sensors mounted above the cells. Surprisingly, vapors may be detected as much as many months before a catastrophic failure or fire finally occurs, in cases of less severe abuse. Under more severe abuse, the vapor release may still occur and still be detected just moments before a catastrophic failure or fire occurs.

Current, voltage, and temperature are what are known to be measured, however there are modes of failure that these existing measurements do not detect (for example mechanical damage.) Often, the system that makes the temperature and electrical measurements fails and actually causes the catastrophic failure of the battery. The vapor detection is an independent and redundant system to that can avert fires, and other problems that are caused by failures of other systems, such as the BMS or charging systems.

Detection of vapors enhances safety because it gives an early warning of the existence of the fault condition that other methods may not be able to detect at such an early stage.

This often allows users to correct the root problem before a fire occurs if the system can sense and report the presence of these vapors.

For example, vehicle system(s) can shut down charging, shut down discharging, increase cooling, warn the operator, send a message via the an on-board communication system (i.e. “On Star®” or local telemetry) or merely log the event for maintenance diagnostic purposes.

The early warning of the presence of vapors emitted by the cells (due to the presence of abnormal conditions) will give advanced warning of a fault condition in the battery pack. This advanced warning will greatly reduce the number of fires and catastrophic battery pack failures.

Previously existing systems do not detect over-pressure of a cell, which causes vapor release, but the vapor detection system of the present invention can detect this. An external temperature measurement type system cannot quickly detect the peak internal temperature of the cell. Hot spots internally can cause over-pressure, vapor release, and a fire originating in even a single cell and thus undetectable to methods which monitor an entire battery pack, but the present invention can detect problems in a single cell.

For example, only an actual fire would be detected by the external temperature sensor type of system, but by then the catastrophic event has already occurred. The vapor detection system of the present invention will sense the vapor release, and warn that a fault condition has occurred before the fire or catastrophic failure occurs.

The disclosure is provided to allow practice of the invention by those skilled in the art without undue experimentation, including the best mode presently contemplated and the presently preferred embodiment. Nothing in this disclosure is to be taken to limit the scope of the invention, which is susceptible to numerous alterations, equivalents and substitutions without departing from the scope and spirit of the invention. The scope of the invention is to be understood from the appended claims.

What is claimed is:

1. A method of detecting battery degradation in a sealed battery having an organic molecular solvent, the method comprising the steps of:
providing a lithium-ion battery;
providing a vapor detector situated so as to sense any vapor emitted from the battery;
providing a response to vapor detection; and
when the vapor detector senses vapor emitted from the battery, actuating the response.

2. The method of detecting battery degradation in a lithium-ion battery of claim 1, wherein the sealed battery is a lithium-ion battery.

3. The method of detecting battery degradation in a lithium-ion battery of claim 2, the response further comprising:
an indicator selected from the group consisting of: lights, visual signals, bells, tones, audible signals, illuminated lettering, haptic signals, and combinations thereof.

4. The method of detecting battery degradation in a lithium-ion battery of claim 2, the response further comprising:
actuation of a fire extinguisher/fire suppression system.

5. The method of detecting battery degradation in a lithium-ion battery of claim 2, the response further comprising:
switching from a first mode of operation of a battery management system which manages the lithium-ion battery to a second mode of operation of the battery management system.

6. The method of detecting battery degradation in a lithium-ion battery of claim 5, the second mode of operation of the battery management system further comprising:
shut down of the battery.

7. The method of detecting battery degradation in a lithium-ion battery of claim 5, the second mode of operation of the battery management system further comprising:
shut down of a portion of the battery.

8. The method of detecting battery degradation in a lithium-ion battery of claim 1, the lithium-ion battery being one member selected from the group consisting of: li-ion batteries with ethylene carbonate solvent, li-ion batteries with dimethyl carbonate solvent, li-ion batteries with diethyl carbonate solvent, composite solvents, solvents of the poly(oxyethylene) family, lithium cobalt oxide batteries, lithium titanate batteries, lithium manganese oxide batteries, lithium iron phosphate batteries, lithium nickel manganese cobalt oxide, lithium nickel cobalt aluminum oxide and combinations thereof.

9. The method of detecting battery degradation in a lithium-ion battery of claim 1, wherein the vapor detector further comprises:
a detector of organic vapor products of lithium-ion battery operation.

10. The method of detecting battery degradation in a lithium-ion battery of claim 1, wherein the vapor detector further comprises:
a detector of flammable vapors.

11. A method of detecting battery degradation in a lithium-ion battery, the method comprising the steps of:
providing a lithium-ion battery immersed in a liquid;
providing a submerged organic molecule detector situated so as to sense organic chemicals emitted from the battery;
providing a response to organic chemical detection; and
when the submerged organic molecule detector senses organic chemicals emitted from the battery, actuating the response.

12. The method of detecting battery degradation in a lithium-ion battery of claim 11, the response further comprising:
an indicator selected from the group consisting of: lights, visual signals, bells, tones, audible signals, illuminated lettering, haptic signals, and combinations thereof.

13. The method of detecting battery degradation in a lithium-ion battery of claim 11, the response further comprising:
switching from a first mode of operation of a battery management system which manages the lithium-ion battery to a second mode of operation of the battery management system.

14. The method of detecting battery degradation in a lithium-ion battery of claim 13, the second mode of operation of the battery management system further comprising:
shut down of the battery.

15. The method of detecting battery degradation in a lithium-ion battery of claim 11, the lithium-ion battery being one member selected from the group consisting of: li-ion batteries with ethylene carbonate solvent, li-ion batteries with dimethyl carbonate solvent, li-ion batteries with diethyl carbonate solvent, composite solvents, solvents of the poly(oxyethylene) family, lithium cobalt oxide batteries, lithium titanate batteries, lithium manganese oxide batteries, lithium iron phosphate batteries, lithium nickel manganese cobalt oxide, lithium nickel cobalt aluminum oxide and combinations thereof.

16. A battery system comprising:
at least one sealed lithium-ion cell;
at least one gas detector situated so as to detect any gas emitted by such sealed lithium-ion cell;
at least one responding system, the gas detector operative to actuate the responding system.

17. The battery system of claim 16, wherein the response further comprises:
an indicator selected from the group consisting of: lights, visual signals, bells, tones, audible signals, illuminated lettering, haptic signals, and combinations thereof.

18. The battery system of claim 16, wherein the response further comprises:
actuation of a fire extinguisher/fire suppression system.

19. The battery system of claim 16, wherein the response further comprises:
switching from a first mode of operation of a battery management system which manages the lithium-ion battery to a second mode of operation of the battery management system.

20. The battery system of claim 5, the second mode of operation of the battery management system further comprising:
shut down of the battery.
